(19) United States
(12) Patent Application Publication
(10) Pub. No.: US 2009/0233025 A1
(43) Pub. Date: Sep. 17, 2009

(54) Multi-Seal Method Capable Structures for Gusseted Flexible Containers

(76) Inventors: Lance L. Cvancara, Appleton, WI (US); Kevin J. Curie, Appleton, WI (US)

Correspondence Address: BANNER & WITCOFF, LTD., TEN SOUTH WACKER DRIVE, SUITE 3000, CHICAGO, IL, 60606, US

(21) Appl. No.: 12/404,082

(22) Filed: Mar. 13, 2009

Related U.S. Application Data
(60) Provisional application No. 61/036,338, filed on Mar. 13, 2008.

(51) Int. Cl. B32B 1/02; B29C 65/08

(52) U.S. Cl. 428/35.7; 156/73.4

(57) ABSTRACT

Flexible films, packages, and methods of making the same are provided where the film is capable of being sealed to itself or to other films by more than one sealing method, including thermal sealing and ultrasonic sealing. In particular, a package includes at least three multilayer films sealed together with an ultrasonic seal, where the outer layers remain intact and do not contain visible perforations at the ultrasonic seal. The multilayer films include at least a sealant layer and an outer layer, and may be separate pieces of multilayer films or one multilayer film that has been folded. A method for sealing a film includes the steps of providing a multilayer film having at least a sealant layer and an outer layer, folding the multilayer film to provide a folded film including at least three layers of multilayer film, and applying mechanical oscillations to seal the folded film.

### FIELD OF THE INVENTION

Embodiments of the present invention relate to flexible films having the capability of being sealed by both thermal and ultrasonic methods. More specifically, embodiments of the present invention relate to a film structure having the capacity to be formed into a package in which a plurality of layers are sealed together, such as in a package including a gusset. In addition, embodiments of the present invention relate to methods of manufacturing the flexible films.

### BACKGROUND OF THE INVENTION

It is generally known to utilize plastic packaging to contain products, such as in flexible plastic containers. For example, flexible plastic packaging for foods and beverages is well known. Flexible plastic films may be employed to form packaging, such as by folding and sealing portions of a single piece, or sealing separate pieces together. Typically, thermoplastic material can be thermally sealed to itself or another polymeric material. Specifically, heat and pressure are applied to the thermoplastic material for a period of time, referred to as the “dwell time,” to melt the polymers. The liquefied polymer molecules at the joint are thus allowed to intersperse, forming a strong bond once the polymeric materials cool and resolidify. Thermal sealing may be easily performed in a continuous manner and is inexpensive to incorporate into a machine design.

An alternate bonding method is ultrasonic sealing. In ultrasonic sealing, mechanical oscillations are transferred under force into a polymeric material, which results in heat friction, as well as intermolecular and boundary friction, at the joint to be sealed. The friction causes a build-up of heat and melts the material at the joint. The melted polymer molecules intermingle, also forming a strong bond after the material has cooled and resolidified. An advantage of ultrasonic sealing is that it provides a quick melting of the polymeric material, and can be concentrated to a specific location more easily than can be accomplished with the thermal sealing technique. Further, ultrasonic seals are readily monitored for quality control and can be formed even through any contamination present on the polymeric material.

The nature of a seal achieved by thermal sealing, as compared to by ultrasonic sealing, is very different. For example, an ultrasonic seal is typically quite narrow in height and forms a deeper impression in the polymeric material on one side of the seal than the opposite. However, it is preferable to provide the option of employing both thermal bonding and ultrasonic bonding of seals on a particular polymeric package, to save time and expense when designing an apparatus for the forming and/or filling of flexible polymer structures. For example, a flexible polymer package containing a food product may be sealed with ultrasonic sealing in order to achieve a substantially smaller headspace than required when employing thermal sealing.

Currently, the formation of ultrasonic bonds is limited to only effectively sealing a couple of layers of flexible films. When a package is formed with side gussets and sealed at one end, for example, at least a portion of the bond will include the front and back walls and four folds of a side wall. Typically, ultrasonic sealing of such a large number of layers results in only a partial seal through the layers, and/or a perforation of at least one of the film layers.

A need, therefore, exists for flexible film polymeric packaging that is capable of being sealed by both thermal and ultrasonic methods, regardless of the number of film layers included in the seal joint. Multilayer films and methods of their manufacture are needed to overcome the disadvantages as noted above with respect to the current limitations of ultrasonic sealing and the ability to use only a single bonding method.

### SUMMARY OF THE INVENTION

Aspects of the present invention relate to multilayer plastic polymeric flexible packaging films capable of being sealed with at least two bonding methods. More specifically, aspects of the present invention relate to a multilayer polymeric flexible film that may be sealed by both thermal and ultrasonic sealing methods through a plurality of layers. In particular, a package comprises at least three multilayer films sealed together with an ultrasonic seal, where the outer layers remain intact and do not contain visible perforations at the ultrasonic seal. The multilayer films include at least a sealant layer and an outer layer, and may be separate pieces of multilayer films or one multilayer film that has been folded. The package may also comprise a thermal seal.

In addition, aspects of the present invention relate to methods for manufacturing the multilayer polymeric films. A method for sealing a film according to an aspect of the invention includes the steps of providing a multilayer film comprising a sealant layer and an outer layer, folding the multilayer film to provide a folded film having at least three layers of multilayer film, and applying mechanical oscillations to seal the folded film without forming visible perforations in the outer layer of the multilayer film. The film may be folded to form a gusset. In an alternate embodiment, more than one separate multilayer film is sealed together.

It is, therefore, an advantage of aspects of the present invention, to provide a polymeric plastic packaging film. Packages made with these multilayer films may contain products such as foodstuffs, pharmaceutical and/or nutraceutical products.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of a single structure multilayer film according to an embodiment of the invention.

FIG. 2 illustrates a perspective view of the single structure multilayer film of FIG. 1, in which the upper and lower ends have been sealed closed.

FIG. 3 illustrates a top plan view of a portion of FIG. 2.

FIG. 4 illustrates an ultrasonic sealing tool with a folded gusset portion of a multilayer film to be sealed.

### DETAILED DESCRIPTION OF EMBODIMENTS OF THE INVENTION

The present invention relates to films, film structures, packages and methods of manufacturing the films, film structures and packages of the present invention. Specifically, the films are capable of being sealed by both thermal sealing and ultrasonic sealing methods. More specifically, the films may be effectively sealed using both thermal sealing and ultrasonic sealing methods through a plurality of film layers. For example, the films may be configured into the shape of a package having side gussets such that at least a portion of one end of the package is sealed through the two film layers of the front and back walls as well as through the four film layers included in the folded side gussets.

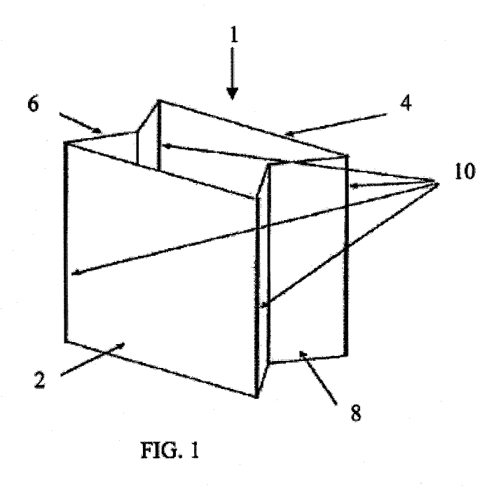

Now referring to the drawings, wherein like numerals refer to like parts, FIG. 1 illustrates a multilayer film 1 according to an embodiment of the invention. The film 1 may be made from a plurality of layers of a variety of polymeric materials, such as oriented polypropylene, polyester, nylon, ionomers, metallocene materials and/or polyolefinic materials, such as polyethylene. The materials may be placed in specific locations within the multilayer film 1 to provide the multi-seal capabilities. Preferably, the film 1 may comprise polyethylene selected from the group consisting of low density polyethylene, medium density polyethylene, and high density polyethylene, and may be made via any known method of making polyethylene, such as via Ziegler-Natta catalysts, or single-site catalysts, such as metallocene catalysts.

The resins or resin blends may be selected for their particular rheology, seal initiation temperature, molecular weight distribution, density, melt index and/or modulus of elasticity in order to provide enhanced ability to be sealed using either thermal or ultrasonic sealing. For example, a resin may be chosen with a high viscosity to prevent the polymer molecules from flowing away from the seal joint due to the mechanical oscillation provided during the ultrasonic sealing. Not only does the mechanical oscillation of ultrasonic sealing affect the sealant layer, but it can also disrupt the structural integrity of the other layers present, such as the outer (e.g., abuse) layer and interior layers of the multilayer film. To provide a successful ultrasonic seal, therefore, it is important that the mechanical oscillation causes the sealant layers to melt and intermingle more quickly than it causes significant damage to the one or more other layers of the multilayer film structure. The damage may be in the form of separation of one or more layers from the adjacent layers resulting from vibration and heat generation from the center of the seal radiating outward. In addition, the damage may result in visible perforations or cuts in the outer and/or interior layers of the film structures. Accordingly, the polymeric content and thickness of the layers of the multilayer film must be selected to exhibit a combination of swiftness of the sealant layer melting and resistance of the one or more other layers to the mechanical oscillation of the ultrasonic seal. In particular, polymeric layers that provide dampening effects when subjected to mechanical oscillation will assist to minimize damage to the interior and outer layers of the multilayer film by not allowing the vibration to travel as far throughout the film as allowed by layers that are not good at dampening.

Further, the film may comprise additives to the polymeric resins such as slip additives, anti-block additives, processing aids, colorants and/or UV blockers. Moreover, the various polymeric films included in the multilayer film 1 may be selected to provide toughness, rigidity, barrier properties, heat resistance, seal strength, cut resistance and/or puncture resistance. A multilayer film used to package a product must include a hermetic, sufficiently strong seal to meet the requirements of the particular product's packaging specification, handling and distribution systems.

The multilayer 1 film may be prepared via coextrusion with other film layers, extrusion or coextrusion coating, adhesive lamination, extrusion lamination or any other method of making multilayer film structures. Preferably, the multilayer film 1 is produced using extrusion lamination. In some embodiments of the invention, portions of the film layers in the multilayer film 1 may be formed to have a greater thickness than other portions of the particular film layers to provide enhanced thermal and ultrasonic sealing capabilities.

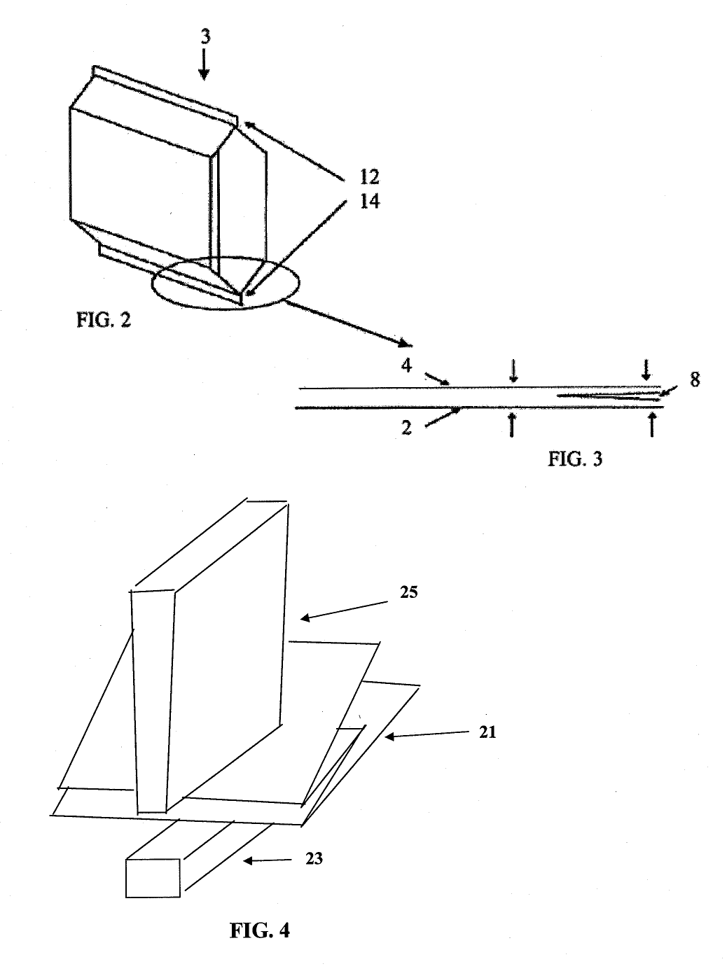

The multilayer film 1 illustrated in FIG. 1 has been formed into an open tube 10 and sealed along each of the side edges with thermal sealing. The tube 10 includes side gussets 6 and 8, which provide additional stability for a container made from the tube 10. The tube 10 also comprises a front panel 2 and a back panel 4, and the tube 10 may be further formed into a container 3 by sealing the open ends, as shown in FIG. 2. Preferably, the sealed ends 12 and 14 of the container 3 are created by employing ultrasonic sealing. An expanded portion of one of the sealed ends 14 of the container is represented in FIG. 3, which clarifies that the portion of the sealed end 14 includes the front panel 2, the back panel 4 and four layers of the multilayer film 1 that make up the side gusset 8. Accordingly, the sealed end 14 of the embodiment of container 3 comprises six layers of the multilayer film 1.

Any number of layers may be incorporated into the multilayer film 1 as may be needed to form a package having desired characteristics. For example, the number of polymeric layers may be increased or decreased to enhance the sealing capability of the multilayer film 1. An embodiment of the film structure of the present invention includes a sealant layer, which readily melts when subjected to thermal or ultrasonic sealing conditions and resolidifies upon cooling. In certain embodiments the sealant layer has a thickness between about 2.0 mils and 4.5 mils and the multilayer film has a total thickness between about 4.0 and 5.5 mils. The thicknesses chosen will depend on the package requirements and ultrasonic sealing conditions.

The sealant layer may comprise a polyolefinic material, for example a polyethylene. The polyolefin may comprise linear low density polyethylene (LLDPE), including all linear polyethylenes with density up to about 0.95 g/cc, low density polyethylene (LDPE), ethylene vinyl acetate (EVA), polybutylene, polypropylene-based plastomers, homopolymers or random copolymers, medium density polyethylene (MDPE), high density polyethylene (HDPE), ultra low density polyethylene, very low density polyethylene, or olefins catalyzed by a single site catalyst such as metallocene. As used herein, the phrase high density polyethylene (“HDPE”) refers to ethylene alpha-olefin copolymers or ethylene homopolymer having a density of about 0.94 g/cm³ or greater. HDPE can be produced with several classes of catalysts, such as Ziegler-Natta catalysts and metallocene catalysts. As used herein, the terms “low density polyethylene” and “LDPE” refer to branched ethylene homopolymers having a density of between about 0.915 g/cm³ and 0.925 g/cm³. The low density of LDPEs is typically due to the presence of branching off of the main polyethylene chain.

Further, the sealant layer may comprise a sealant coextrusion. In certain embodiments of the invention, the sealant layer comprises ethylene vinyl alcohol (EVOH) present within a sealant coextrusion. EVOH is an oxygen and flavor barrier material and may be included in the interior of the sealant coextrusion, for example comprising the following structure: LDPE-HDPE/LLDPE-Tie/EVOH/LLDPE-Tie/Sealant.

The sealant layer may be adhered to an interior second, or middle, polymeric layer, such as comprising polyethylene terephthalate (PET). The one or more interior layers may comprise polypropylene, polyamide (e.g., nylon), polyester, PET, or combinations thereof. The sealant layer and middle layer may be adhered by coextrusion or by an adhesive layer. In an embodiment, a tie or adhesive layer may be an ethylene acrylic acid polymer (EAA), a coextrusion of low density polyethylene (LDPE) and EAA copolymer, or an anhydride modified polyethylene. In certain embodiments, the tie or adhesive layer comprises maleic anhydride modified polyethylene copolymer, such as ethylene vinyl acetate (EVA)-based or linear low density polyethylene (LLDPE)-based adhesive. The tie or adhesive layer may alternatively comprise any of the various other polymeric adhesives commonly used in the art of making multilayer films.

In addition, the multilayer film 1 may include a third, or outer, layer, preferably comprising oriented polypropylene, which is disposed adjacent to the middle layer, if present. The outer layer may comprise, for example, polyethylene, polyester, or polypropylene. If the polymeric material in the outer layer and the sealant layer are selected such that they can adhere to each other without requiring an adhesive layer between them, the sealing process may additionally seal any directly adjacent outer and sealant layers to each other, such as when a gusset seal is formed. Typically, the multilayer film 1 comprises at least a sealant layer and an outer layer, and depending on the physical requirements of the package to be made using the multilayer film, film 1 may comprise various suitable interior, or middle, layers.

A multilayer film 1 can be created by combining a sealant layer, a middle layer and an outer layer, preferably in a continuous process. These layers can be combined through the use of an adhesive, via coextrusion or combined in other methods known in the art. In one embodiment, the adhesive may be a non-aqueous adhesive, such as an ethylene acrylic acid copolymer. The multilayer film 1 may be a stand alone coextrusion of a plurality of different materials and may be used for the packaging of a product or may be the final product itself. The multilayer film 1 may further be formed into a structure for filling with a product later, or be filled as a part of the forming method. In certain embodiments, the multilayer film 1 is folded and sealed to itself, whereas in other embodiments, the multilayer film 1 is placed adjacent to one or more other multilayer films and sealed together.

Ultrasonic sealing may be performed using an ultrasonic welding system. Generally ultrasonic welding systems comprise a press for applying pressure to the one or more multilayer films, an anvil upon which the multilayer film(s) are placed, a power supply to convert power into a high frequency electrical signal, a transducer for transforming the high frequency signal to mechanical vibration, a booster for raising the amplitude of the vibration and transmitting it to a horn, and a horn, for transferring the mechanical oscillation to the one or more multilayer films. For sealing of flexible polymers, the power supply may provide an electrical signal at about 20, 30, 35, or 40 kHz.

A portion of an ultrasonic welding system is illustrated in FIG. 4, including a multilayer film 21 having a gusset folded into the film. The film 21 is shown inserted between the anvil 23 and the horn 25 of an ultrasonic welding system. Each horn and anvil combination, commonly referred to as a “tool”, provides a slightly different mechanical oscillation at the same frequency. Indeed, the shape of the tool may be tuned to vibrate at a specific frequency, and the shape amplifies the vibration. Further, the clearance between the horn and anvil can vary a small amount and the film thickness is quite sensitive to clearances in the tool design. Consequently, the layer thicknesses of a multilayer film may need to be somewhat adjusted if a different tool is to be employed, in order to achieve successful sealing of the sealant layers without damaging any other layers present, (i.e., the outer layer and/or an interior layer).

The layer thicknesses of a multilayer film would also need to be adjusted if the frequency of the oscillation is changed. For example, the thicknesses of the interior and/or outer layers may have to be adjusted to allow the integrity of the layer(s) to withstand a higher frequency oscillation than previously applied to the multilayer film to form an ultrasonic seal.

The differing seal methods used to form a product or package from the multilayer film 1 may occur in any order. For example, a thermal seal could be formed first, followed by an ultrasonic seal or any other type of seal, to create the product or package. Forming or filling a package from the multilayer film 1 may also occur in any order with the seals as well. The ability to use both thermal and ultrasonic sealing methods allows products to be formed inexpensively, and if needed, in a non-linear format.

### EXAMPLES

### Example 1

A multilayer film structure was formed using coextrusion lamination, and had the following structure, from outer abuse layer to sealant layer: 70 gauge oriented polypropylene/adhesive/48 gauge PET/adhesive/3.0-4.5 mil coextrusion barrier sealant. The film structure was folded to form a gusset, which was sealed using ultrasonic sealing. The resulting gusset seal was evaluated visually and determined to be acceptable, without any noticeable damage to any of the film layers at or near the location of the ultrasonic seal. A thermal seal was also successfully formed on the film structure. The thickness of the oriented polypropylene layer and/or the sealant layer may be selected to be thicker or thinner depending on the requirements of the product to be packaged using the multilayer film. Alternatively, a sealant layer which does not comprise EVOH may be employed. In addition, a foil barrier layer may be included as an interior layer in any the structure.

### Example 2

A multilayer film structure was formed using coextrusion lamination, and had the following structure, from outer abuse layer to sealant layer: 70 gauge oriented polypropylene/adhesive/70 gauge oriented polypropylene/adhesive/3.0-4.5 mil coextrusion barrier sealant. The film structure was folded to form a gusset, which was sealed using ultrasonic sealing. The resulting gusset seal was evaluated visually and determined to be acceptable, without any noticeable damage to any of the film layers at or near the location of the ultrasonic seal. A thermal seal was also successfully formed on the film structure.

### Example 3

A multilayer film structure was formed using coextrusion lamination, and had the following structure, from outer abuse layer to sealant layer: 70 gauge oriented polypropylene/adhesive/60 gauge nylon/adhesive/3.0-4.5 mil coextrusion barrier sealant. The film structure was folded to form a gusset, which was sealed using ultrasonic sealing. The resulting gusset seal was evaluated by visually and determined to be acceptable, without any noticeable damage to any of the film layers at or near the location of the ultrasonic seal. A thermal seal was also successfully formed on the film structure.

### Example 4

Various other multilayer structures may be formed, such as structures having an outer layer, an adhesive, and a sealant layer. For instance, a multilayer film structure may be formed having the following structure: 70 gauge oriented polypropylene/adhesive/3.0 mil coextrusion barrier sealant. Moreover, the thickness of the oriented polypropylene layer and/or the sealant layer may be selected to be thicker or thinner depending on the requirements of the product to be packaged using the multilayer film or other desired characteristics of the multilayer film. Also, a sealant layer may be used that does not comprise EVOH. In addition, a foil barrier layer may be included as an interior layer in any of the structures.

While the invention has been described with respect to specific examples including presently preferred modes of carrying out the invention, those skilled in the art will appreciate that there are numerous variations and permutations of the above described structures that fall within the spirit and scope of the invention. It should be understood that the invention is not limited in its application to the details of construction and arrangements of the components set forth herein. Variations and modifications of the foregoing are within the scope of the present invention. It is also being understood that the invention disclosed and defined herein extends to all alternative combinations of two or more of the individual features mentioned or evident from the text. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art. It is therefore contemplated that such modifications can be made without departing from the spirit or scope of the present invention as defined in the appended claims.

1. A package comprising:
a first multilayer film portion comprising a first sealant layer and a first outer layer;
a second multilayer film portion disposed adjacent to the first multilayer film portion, the second multilayer film comprising a second sealant layer and a second outer layer;
a third multilayer film portion disposed adjacent to the second multilayer film portion, the third multilayer film comprising a third sealant layer and a third outer layer; and
an ultrasonic seal sealing the first, second and third multilayer film portions together, wherein the first, second and third outer layers remain intact and do not comprise visible perforations at the ultrasonic seal.

2. The package of claim 1, wherein the first, second and third multilayer film portions are portions of the same multilayer film and wherein the multilayer film has been folded.

3. The package of claim 1, wherein the first and second multilayer film portions are portions of separate multilayer film pieces.

4. The package of claim 1, wherein at least one of the first, second and third sealant layers comprises a polyolefin.

5. The package of claim 1, wherein at least one of the first, second and third multilayer films has a thickness of between 4.0 mils and 5.5 mils.

6. The package of claim 1, further comprising a fourth multilayer film disposed adjacent the third multilayer film.

7. The package of claim 1, wherein the ultrasonic seal comprises a gusset formation.

8. The package of claim 1, further comprising a thermal seal.

9. A method for sealing a multilayer film comprising:
providing a multilayer film comprising a sealant layer and an outer layer;
folding the multilayer film to provide a folded film comprising at least three layers of multilayer film; and
applying mechanical oscillations to the folded film to seal the folded film without forming visible perforations in the outer layer of the multilayer film.

10. The method of claim 9, wherein the sealant layer comprises a polyolefin.

11. The method of claim 9, wherein the multilayer film has a thickness of between 4.0 mils and 5.5 mils.

12. The method of claim 9, wherein the multilayer film is folded in a gusset formation.

13. The method of claim 9, wherein the outer layer comprises a material selected from the group consisting of oriented polypropylene, polyethylene, and polyester.

14. The method of claim 9, further comprising a thermal seal.

15. A method for sealing a package comprising:
providing a plurality of multilayer films, each of the plurality of multilayer films comprising a sealant layer and an outer layer;
placing the plurality of multilayer films adjacent each other; and
applying mechanical oscillations to the adjacent plurality of multilayer films to seal the plurality of multilayer film together without forming visible perforations in the outer layers of the plurality of multilayer films, wherein the plurality of multilayer films comprises at least three multilayer films.

16. The method of claim 15, wherein the plurality of multilayer films each has a thickness between 4.0 mils and 5.5 mils.

17. The method of claim 15, wherein each of the outer layers of the plurality of multilayer films is independently selected from the group consisting of oriented polypropylene, polyethylene, and polyester.

18. The method of claim 15, wherein at least one of the sealant layers of the plurality of multilayer films comprises a polyolefin.

19. The method of claim 15, wherein the plurality of multilayer films comprises four multilayer films.

20. The method of claim 15, further comprising a thermal seal.
